(19) United States
(12) Patent Application Publication
(10) Pub. No.: US 2008/0143256 A1
(43) Pub. Date: Jun. 19, 2008

(54) PLASMA DISPLAY PANEL

(76) Inventor: Byungjoon RHEE, Seoul (KR)

Correspondence Address: KED & ASSOCIATES, LLP, P.O. Box 221200, Chantilly, VA, 20153-1200, US

(21) Appl. No.: 11/955,759

(22) Filed: Dec. 13, 2007

(30) Foreign Application Priority Data
Dec. 14, 2006 (KR) 10-2006-0128254

(51) Int. Cl. H01J 17/49

(52) U.S. Cl. 313/585; 313/586

(57) ABSTRACT

A plasma display panel is disclosed. The plasma display panel includes a front substrate, a rear substrate facing the front substrate, a barrier rib that is positioned between the front substrate and the rear substrate to partition a discharge cell, a first electrode and a second electrode that face each other to be spaced apart from each other at the discharge cell therebetween, and a dielectric layer that covers the first electrode and the second electrode. At least one of the first electrode and the second electrode includes a depression formed on a facing surface of the first electrode and the second electrode. The dielectric layer includes a groove formed between the first electrode and the second electrode.

This application claims the benefit of Korean Patent Application No. 10-2006-0128254 filed on Dec. 14, 2006, which is hereby incorporated by reference.

### BACKGROUND OF THE DISCLOSURE

1. Field of the Disclosure

An exemplary embodiment relates to a plasma display panel.

2. Description of the Related Art

A plasma display apparatus generally includes a plasma display panel displaying an image, and a driver positioned in the rear of the plasma display panel to drive the plasma display panel.

The plasma display panel has the structure in which barrier ribs formed between a front substrate and a rear substrate form a plurality of discharge cells by partitioning a space between the front substrate and the rear substrate. Each discharge cell is filled with an inert gas containing a main discharge gas such as neon (Ne), helium (He) or a mixture of Ne and He, and a small amount of xenon (Xe). The plurality of discharge cells form one pixel. For instance, a red discharge cell, a green discharge cell, and a blue discharge cell form one pixel.

When the plasma display panel is discharged by a high frequency voltage, the inert gas generates vacuum ultraviolet rays, which thereby cause phosphors formed between the barrier ribs to emit light, thus displaying an image.

### SUMMARY OF THE DISCLOSURE

Exemplary embodiments provide a plasma display panel generating an opposite discharge.

Exemplary embodiments also provide a plasma display panel generating an opposite discharge and a surface discharge.

Exemplary embodiments also provide a plasma display panel capable of reducing reactive power consumption.

In one aspect, a plasma display panel comprises a front substrate, a rear substrate that faces the front substrate, a barrier rib that is positioned between the front substrate and the rear substrate to partition a discharge cell, a first electrode and a second electrode that face each other to be spaced apart from each other at the discharge cell therebetween, at least one of the first electrode and the second electrode including a depression formed on a facing surface of the first electrode and the second electrode, and a dielectric layer that covers the first electrode and the second electrode, the dielectric layer including a groove formed between the first electrode and the second electrode.

A height of each of the first electrode and the second electrode may be larger than a width of each of the first electrode and the second electrode.

A ratio of the height of each of the first electrode and the second electrode to a height of the barrier rib may lie substantially in a range between ⅛ and 1.

The depression may be formed to extend along an extending direction of the first electrode.

A width of the depression may lie substantially in a range between 7 μm and 13 μm. A ratio of a depth of the depression to a width of the first electrode or the second electrode may lie substantially in a range between ⅓ and ⅔.

At least one of the first electrode and the second electrode may be a bus electrode.

In another aspect, a plasma display panel comprises a front substrate, a rear substrate that faces the front substrate, a barrier rib that is positioned between the front substrate and the rear substrate to partition a discharge cell, a first electrode and a second electrode that are positioned parallel to each other to be spaced apart from each other at the discharge cell therebetween, the first electrode and the second electrode each including a transparent electrode that is formed on the front substrate in the plane form and a bus electrode, the bus electrodes of the first and second electrodes facing each other to be spaced apart from each other at the discharge cell therebetween, and a dielectric layer that covers the first electrode and the second electrode, the dielectric layer including a groove formed between the first electrode and the second electrode.

A height of the bus electrode may be larger than a width of the bus electrode.

An interval between the transparent electrodes of the first and second electrodes may be shorter than an interval between the bus electrodes of the first and second electrodes.

The groove may include a first groove formed on the dielectric layer between the bus electrodes, and a second groove formed on the first groove between the transparent electrodes.

A first thickness of the dielectric layer contacting the transparent electrodes may be larger than a second thickness of the dielectric layer contacting the bus electrodes.

An interval between the bus electrodes may be larger than a height of the barrier rib.

An interval between the bus electrodes may lie substantially in a range between 150 μm and 350 μm.

In yet another aspect, a plasma display panel comprises a front substrate, a rear substrate that faces the front substrate, a barrier rib that is positioned between the front substrate and the rear substrate to partition a discharge cell, a first electrode and a second electrode that face each other to be spaced apart from each other at the discharge cell therebetween, the first electrode and the second electrode each including a bus electrode, the bus electrodes of the first and second electrodes facing each other to be spaced apart from each other at the discharge cell therebetween, a third electrode that intersects the first electrode and the second electrode in the discharge cell, a height of the third electrode being smaller than a height of each of the bus electrodes, and a dielectric layer that covers the first electrode and the second electrode, the dielectric layer including a groove formed between the first electrode and the second electrode.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 shows a plasma display apparatus including a plasma display panel according to an exemplary embodiment;

FIG. 2 is a schematic partial perspective view of the plasma display panel according to the exemplary embodiment;

FIG. 3 is an enlarged view of a portion A of FIG. 2;

FIG. 4 is a schematic partial perspective view of a front substrate for explaining a groove;

FIG. 5 is a schematic partial perspective view of the front substrate for explaining a groove of different shape from the groove of FIG. 4;

FIG. 6 is a schematic cross-sectional view of another implementation of the plasma display panel according to the exemplary embodiment; and

FIG. 7 is a schematic cross-sectional view of another implementation of the plasma display panel according to the exemplary embodiment.

### DETAILED DESCRIPTION OF EMBODIMENTS

Reference will now be made in detail embodiments of the invention examples of which are illustrated in the accompanying drawings.

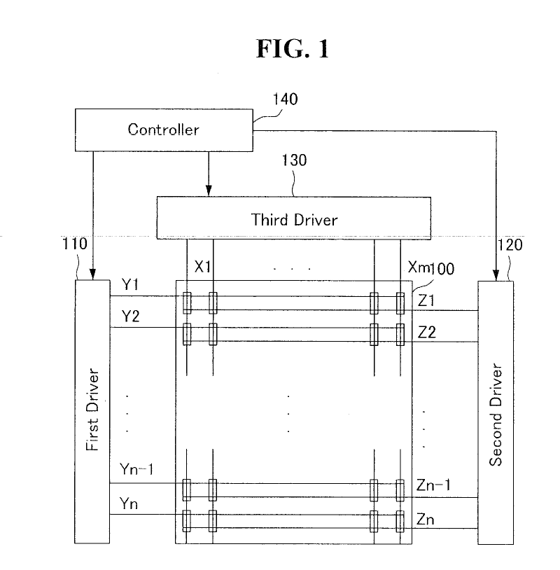

FIG. 1 shows a plasma display apparatus including a plasma display panel according to an exemplary embodiment.

As shown, the plasma display apparatus includes a plasma display panel 100, a first driver 110, a second driver 120, a third driver 130, and a controller 140.

The plasma display panel 100 includes first electrodes Y1 to Yn, second electrodes Z1 to Zn, and third electrodes X1 to Xm positioned in an intersection direction of a formation direction of the first electrodes Y1 to Yn and the second electrodes Z1 to Zn.

The first driver 110 supplies driving signals to the first electrodes Y1 to Yn during a reset period, an address period and a sustain period. For instance, the first driver 110 may supply at least one of a setup signal or a set-down signal to the first electrodes Y1 to Yn during the reset period, may supply a scan reference voltage and a scan signal for scanning each discharge cell to the first electrodes Y1 to Yn during the address period, and may supply a first sustain signal for generating a sustain discharge to the first electrodes Y1 to Yn during the sustain period.

The second driver 120 supplies driving signals to the second electrodes Z1 to Zn during the sustain period. For instance, the second driver 120 may supply a second sustain signal for generating a sustain discharge to the second electrodes Z1 to Zn during the sustain period so that the first sustain signal and the second sustain signal are alternately supplied or overlap each other.

The third driver 130 supplies driving signals to the third electrodes X1 to Xm during the address period. For instance, the third driver 130 may supply a data signal to the third electrodes X1 to Xm in response to a control signal received from the controller 140 during the address period.

The controller 140 supplies control signals for controlling the first, second and third drivers 110, 120 and 130 to the first, second and third drivers 110, 120 and 130 in each subfield of a frame.

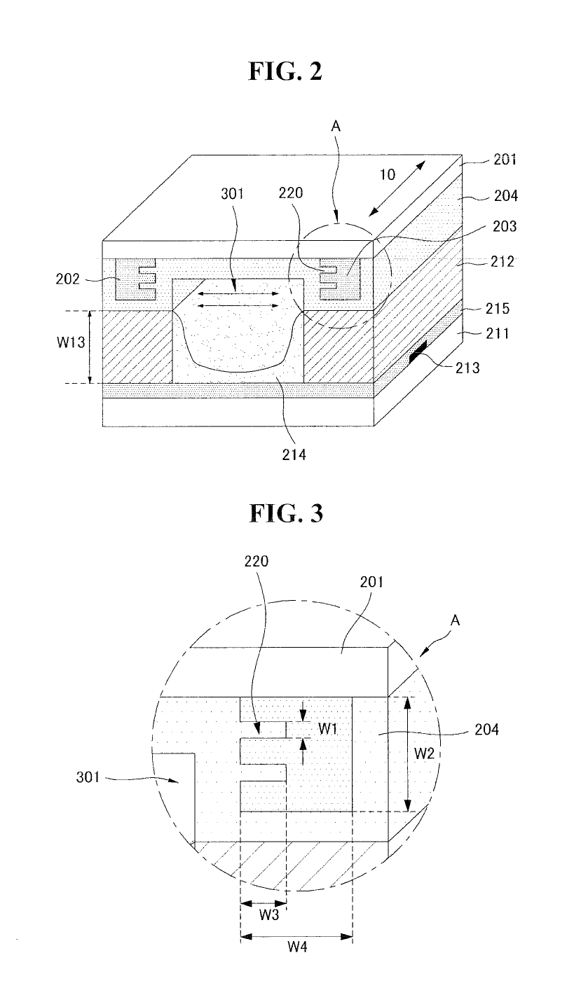

FIG. 2 is a schematic partial perspective view of the plasma display panel according to the exemplary embodiment. FIG. 3 is an enlarged view of a portion A of FIG. 2.

As shown, the plasma display panel 100 according to the exemplary embodiment includes a front substrate 201 and a rear substrate 211 that face each other. First and second electrodes 202 and 203 each having a height of W2 are positioned on the front substrate 201, and a third electrode 213 is positioned on the rear substrate 211 to intersect the first and second electrodes 202 and 203. A height of each of the first and second electrodes 202 and 203 may be larger than a height of the third electrode 213.

Each of the first electrode 202 and the second electrode 203 may include only a bus electrode. Since the first electrode 202 and the second electrode 203 each include only the bus electrode without a transparent electrode in the exemplary embodiment, the manufacturing cost can be reduced.

Because the first electrode 202 and the second electrode 203 each have the height W2, the first electrode 202 faces the second electrode 203. Accordingly, since an opposite discharge is induced between the first electrode 202 and the second electrode 203, the discharge efficiency can be improved.

More specifically, a ratio W2/W13 of the height W2 of the first and second electrodes 202 and 203 to a height W13 of a barrier rib 212 may lie substantially in a range between 1/10 and 1. Further, the ratio W2/W13 may lie substantially in a range between ⅛ and 1.

When the ratio W2/W13 is equal to or larger than 1/10, a stable opposite discharge is induced between the first electrode 202 and the second electrode 203. Further, when the ratio W2/W13 is larger than 1 (i.e., the height W2 of the first and second electrodes 202 and 203 is larger than the height W13 of the barrier rib 212), a coating area of a phosphor coated on the discharge cell is reduced as the height W13 of the barrier rib 212 is reduced. Hence, a light-emission luminance of the discharge cell is low.

Each of the first electrode 202 and the second electrode 203 may include at least one depression 220. The depressions 220 are formed in an area where the first electrode 202 faces the second electrode 203 (i.e., in a facing surface of the first electrode 202 and the second electrode 203).

A capacitance between the first electrode 202 and the second electrode 203 is reduced by forming the depressions 220 in the facing surface of the first electrode 202 and the second electrode 203, and thus reactive power consumption can be reduced. In other words, because the capacitance between the first electrode 202 and the second electrode 203 is proportional to an area of each of the first electrode 202 and the second electrode 203, the area of each of the first electrode 202 and the second electrode 203 decreases because of the depression 220. Hence, the capacitance between the first electrode 202 and the second electrode 203 is reduced.

A strong magnetic field is induced in projections of the first and second electrodes 202 and 203 due to the depression 220, thereby increasing a wall charge density. Hence, the discharge efficiency can be improved.

It is advantageous that the depression 220 is formed to extend along an arrow direction 10 shown in FIG. 2 in consideration of its manufacturing process. Accordingly, the depression 220 forms a slit. In this case, the first electrode 202 and the second electrode 203 can be more precisely and more easily formed by stacking electrodes each having a different width.

A width W1 of the depression 220 may lie substantially in a range between 7 μm and 13 μm. When the width W1 of the depression 220 is smaller than 7 μm, a reduction effect in the reactive power consumption is small. When the width W1 of the depression 220 is larger than 13 μm, a strength of an electric field induced in the depression 220 is excessively large.

A ratio W3/W4 of a depth W3 of the depression 220 to a width W4 of the first and second electrodes 202 and 203 may lie substantially in a range between ⅓ and ⅔.

Although the above description has been made with respect to a case where the first and second electrodes 202 and 203 each include one depression 220, the number of depressions 220 may be variously changed depending on the size of the first and second electrodes 202 and 203.

An upper dielectric layer 204 for covering the first and second electrodes 202 and 203 is formed on the front substrate 201 on which the first and second electrodes 202 and 203 are formed. The upper dielectric layer 204 limits discharge currents of the first electrode 202 and the second electrode 203, and provides electrical insulation between the first electrode 202 and the second electrode 203.

A protective layer (not shown) may be formed on an upper surface of the upper dielectric layer 204 so as to facilitate discharge conditions. The protective layer may be formed through a method for depositing a material such as magnesium oxide (Mgo) on the upper dielectric layer 204.

The upper dielectric layer 204 may further include a groove 301 so as to more effectively generate an opposite discharge between the first electrode 202 and the second electrode 203. The groove 301 is formed by patterning the upper dielectric layer 204 nearby a discharge gap corresponding to an interval between the first and second electrodes 202 and 203. Therefore, the groove 301 is positioned between the first electrode 202 and the second electrode 203.

The third electrode 213 is positioned on the rear substrate 211. A lower dielectric layer 215 covering the third electrode 213 is positioned on the rear substrate 211, and provides electrical insulation between the third electrodes 213.

Barrier ribs 212 are formed on the lower dielectric layer 215 to partition discharge spaces (i.e., the discharge cells). A phosphor is coated from a wall surface to a bottom surface of the barrier rib 212, thus forming a phosphor layer 214. The discharge cell may be divided into a red discharge cell, a green discharge cell, and a blue discharge cell depending on a color of light produced by the phosphor.

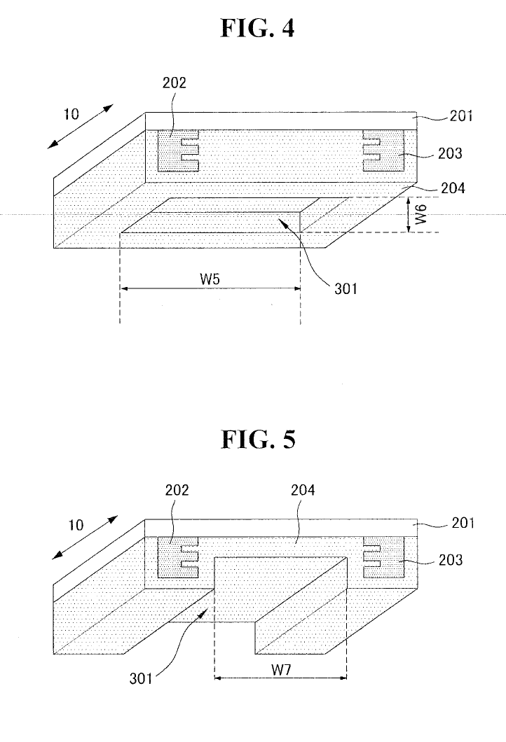

FIGS. 4 and 5 are schematic partial perspective views of the front substrate 201 on which the groove 301 having a different shape is formed, respectively.

As shown, the upper dielectric layer 204 is formed on the front substrate 201 while covering the first electrode 202 and the second electrode 203. The upper dielectric layer 204 includes the groove 301 between the first electrode 202 and the second electrode 203. The groove 301 is formed by removing a portion of the upper dielectric layer 204 between the first and second electrodes 202 and 203.

The groove 301, as shown in FIG. 4, may be formed along each discharge cell. In this case, a transverse width W5 of the groove 301 may be substantially equal to an interval between the barrier ribs (not shown) formed in a first direction 10, and a longitudinal width W6 may be smaller than a discharge gap corresponding to an interval between the first and second electrodes 202 and 203.

The groove 301, as shown in FIG. 5, may be formed to extend along the first direction 10. In case of a closed-type discharge cell, an exhaust characteristic of the plasma display panel can be improved by communicating between the discharge cells.

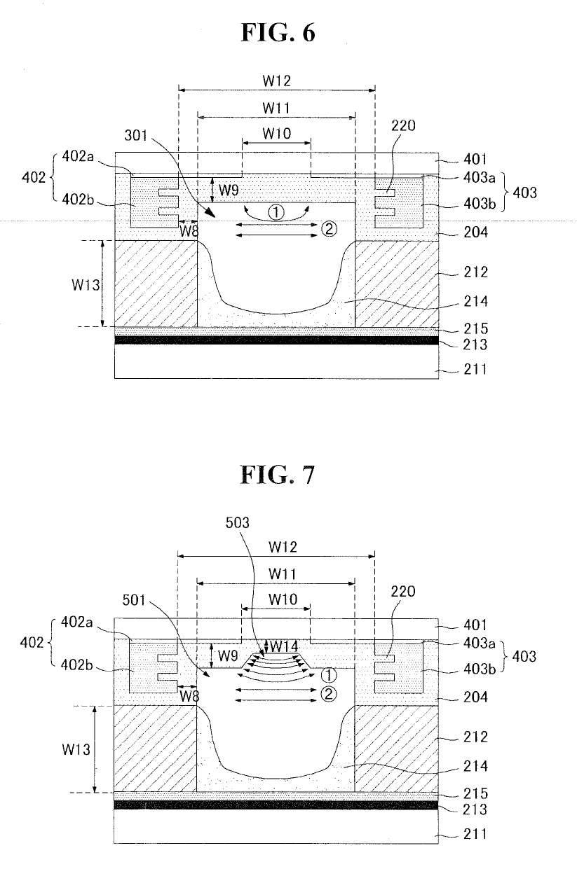

FIG. 6 is a schematic cross-sectional view of another implementation of the plasma display panel according to the exemplary embodiment.

As shown, a first electrode 402 includes a first bus electrode 402b and a first transparent electrode 402a positioned between the first bus electrode 402b and the front substrate 201. A second electrode 403 includes a second bus electrode 403b and a second transparent electrode 403a positioned between the second bus electrode 403b and the front substrate 201. A width of each of the first and second transparent electrodes 402a and 403a may be larger than a width of each of the first and second bus electrodes 402b and 403b, and the first and second transparent electrodes 402a and 403a are positioned in the plane form because a height of the first and second transparent electrodes 402a and 403a is much smaller than the width thereof. Hence, a surface discharge is induced between the first transparent electrode 402a and the second transparent electrode 403a.

As compared with the first and second transparent electrodes 402a and 403a, the first and second bus electrodes 402b and 403b have a projecting shape toward the rear substrate 211 because a height of the first and second bus electrodes 402b and 403b is larger than the width thereof. Hence, the first bus electrode 402b faces the second bus electrode 403b. An opposite discharge is induced between the first bus electrode 402b and the second bus electrode 403b.

An interval W12 between the first bus electrode 402b and the second bus electrode 403b may larger than a height W13 of a barrier rib. The interval W12 may lie substantially in a range between 150 μm and 350 μm. An electrode structure in which an interval between the electrodes lies substantially in a range between 150 μm and 350 μM is defined as a long-gap structure. Accordingly, the first and second bus electrodes 402b and 403b may have a long-gap structure.

Because the plasma display panel 100 having the long-gap structure can use a positive column region of a discharge region, the discharge efficiency can be improved.

The interval W12 between the first and second bus electrodes 402b and 403b may be larger than an interval W11 between the barrier ribs 212. An interval W10 between the first and second transparent electrodes 402a and 403a may be shorter than the interval W12 between the first and second bus electrodes 402b and 403b. The first and second transparent electrodes 402a and 403a may have a short-gap structure.

Because the plasma display panel 100 has the short-gap and long-gap structures, a surface discharge (indicated as \hat{1} in FIG. 6) starts to occur between the first and second transparent electrodes 402a and 403a having the short-gap structure, and then an opposite discharge (indicated as \hat{2} in FIG. 6) occurs between the first and second bus electrodes 402b and 403b having the long-gap structure. The plasma display panel having the short-gap structure can be driven at a low voltage because the interval between the electrodes is short. Because the opposite discharge occurs in the entire portion of each discharge cell in the long-gap structure, the discharge efficiency and the light emission luminance can be improved.

A first thickness W9 of the upper dielectric layer 204 contacting the first and second transparent electrodes 402a and 403a is larger than a second thickness W8 of the upper dielectric layer 204 contacting the first and second bus electrodes 402b and 403b. Hence, since an influence of an electric field caused by the first and second transparent electrodes 402a and 403a is minimized during the opposite discharge (\hat{2}) following the surface discharge (\hat{1}), the discharge efficiency of the opposite discharge (\hat{2}) can be improved.

FIG. 7 is a schematic cross-sectional view of another implementation of the plasma display panel according to the exemplary embodiment. A configuration of the plasma display panel shown in FIG. 7 is the substantially same as a configuration of the plasma display panel shown in FIG. 6 except a configuration of a groove.

As shown, the upper dielectric layer 204 includes a first groove 501 and a second groove 503. The second groove 503 is positioned on the first groove 501, more specifically, between the first transparent electrode 402a and the second transparent electrode 403a. A thickness W14 of the second groove 503 is smaller than a thickness W9 of the first groove 501

Accordingly, because a path of a surface discharge (\hat{1}) generated between the first and second transparent electrodes 402a and 403a shortens due to the second groove 503, a firing voltage can be further reduced and a voltage magnitude of a sustain signal used to generate a sustain discharge can be reduced. Further, since a circuit for generating the sustain signal does not use elements having a high withstanding voltage characteristic to drive the plasma display panel having the long-gap structure, the manufacturing cost can be reduced.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display panel comprising:
a front substrate;
a rear substrate that faces the front substrate;
a barrier rib that is positioned between the front substrate and the rear substrate to partition a discharge cell;
a first electrode and a second electrode that face each other to be spaced apart from each other at the discharge cell therebetween, at least one of the first electrode and the second electrode including a depression formed on a facing surface of the first electrode and the second electrode; and
a dielectric layer that covers the first electrode and the second electrode, the dielectric layer including a groove formed between the first electrode and the second electrode.

2. The plasma display panel of claim 1, wherein a height of each of the first electrode and the second electrode is larger than a width of each of the first electrode and the second electrode.

3. The plasma display panel of claim 2, wherein a ratio of the height of each of the first electrode and the second electrode to a height of the barrier rib lies substantially in a range between ⅛ and 1.

4. The plasma display panel of claim 1, wherein the depression is formed to extend along an extending direction of the first electrode.

5. The plasma display panel of claim 1, wherein a width of the depression lies substantially in a range between 7 μm and 13 μM.

6. The plasma display panel of claim 1, wherein a ratio of a depth of the depression to a width of the first electrode or the second electrode lies substantially in a range between ⅓ and ⅔.

7. The plasma display panel of claim 1, wherein at least one of the first electrode and the second electrode is a bus electrode.

8. A plasma display panel comprising:
a front substrate;
a rear substrate that faces the front substrate;
a barrier rib that is positioned between the front substrate and the rear substrate to partition a discharge cell;
a first electrode and a second electrode that are positioned parallel to each other to be spaced apart from each other at the discharge cell therebetween, the first electrode and the second electrode each including:
a transparent electrode that is formed on the front substrate in the plane form; and
a bus electrode, the bus electrodes of the first and second electrodes facing each other to be spaced apart from each other at the discharge cell therebetween; and
a dielectric layer that covers the first electrode and the second electrode, the dielectric layer including a groove formed between the first electrode and the second electrode.

9. The plasma display panel of claim 8, wherein a height of the bus electrode is larger than a width of the bus electrode.

10. The plasma display panel of claim 8, wherein an interval between the transparent electrodes of the first and second electrodes is shorter than an interval between the bus electrodes of the first and second electrodes.

11. The plasma display panel of claim 10, wherein the groove includes a first groove formed on the dielectric layer between the bus electrodes, and a second groove formed on the first groove between the transparent electrodes.

12. The plasma display panel of claim 8, wherein a first thickness of the dielectric layer contacting the transparent electrodes is larger than a second thickness of the dielectric layer contacting the bus electrodes.

13. The plasma display panel of claim 8, wherein an interval between the bus electrodes is larger than a height of the barrier rib.

14. The plasma display panel of claim 8, wherein an interval between the bus electrodes lies substantially in a range between 150 μm and 350 μm.

15. A plasma display panel comprising:
a front substrate;
a rear substrate that faces the front substrate;
a barrier rib that is positioned between the front substrate and the rear substrate to partition a discharge cell;
a first electrode and a second electrode that face each other to be spaced apart from each other at the discharge cell therebetween, the first electrode and the second electrode each including a bus electrode, the bus electrodes of the first and second electrodes facing each other to be spaced apart from each other at the discharge cell therebetween;
a third electrode that intersects the first electrode and the second electrode in the discharge cell, a height of the third electrode being smaller than a height of each of the bus electrodes; and
a dielectric layer that covers the first electrode and the second electrode, the dielectric layer including a groove formed between the first electrode and the second electrode.

16. The plasma display panel of claim 15, wherein the first electrode and the second electrode each include a transparent electrode that is formed between the front substrate and the bus electrode in the plane form, and
an interval between the transparent electrodes of the first and second electrodes is shorter than an interval between the bus electrodes of the first and second electrodes.

17. The plasma display panel of claim 16, wherein the groove includes a first groove formed on the dielectric layer between the bus electrodes, and a second groove formed on the first groove between the transparent electrodes.

18. The plasma display panel of claim 16, wherein at least one of the bus electrodes of the first and second electrodes includes a depression formed on a facing surface of the bus electrodes.
